(19) United States
(12) Patent Application Publication
(10) Pub. No.: US 2005/0122870 A1
(43) Pub. Date: Jun. 9, 2005

(54) Information recording medium, recording and/or reproducing method, and recording and/or reproducing apparatus

(75) Inventors: Sung-hee Hwang, Seoul (KR); Jung-wan Ko, Suwon-Si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 10/979,812

(22) Filed: Nov. 3, 2004

(30) Foreign Application Priority Data
Nov. 11, 2003 (KR) 2003-79605

(51) Int. Cl. G11B 5/09

(52) U.S. Cl. 369/53.15; 369/53.2; 369/47.14

(57) ABSTRACT

An information recording medium, a recording and/or reproducing method, and a recording and/or reproducing apparatus. The recording and/or reproducing apparatus includes: a writing and/or reading unit which records data on and/or reads data from the information recording medium including a lead-in area, a data area including a user data area in which user data is recorded and a spare area in which replacement data updating the user data is recorded, and a lead-out area; and a controller which reads replacement enforcement flag information indicating a status of logical overwriting according to which the replacement data is recorded in the spare area from one of the lead-in area and the lead-out area and controls the writing and/or reading unit to update the user data with reference to the replacement enforcement flag information.

### CROSS-REFERENCE TO RELATED APPLICATION

This application claims the priority of Korean Patent Application No. 2003-79605, filed on Nov. 11, 2003 in the Korean Intellectual Property Office, the disclosure of which is incorporated herein in its entirety by reference.

### BACKGROUND OF THE INVENTION

1. Field of the Invention

The present invention relates to an information recording medium, and more particularly, to an information recording medium, a recording and/or reproducing method, and a recording and/or reproducing apparatus.

2. Description of the Related Art

Recorded data cannot be overwritten on write-once media. As a result, only a particular recording method to record data on this type of media such as disc-at-once recording, and a track-unit-sequential recording has been used.

A disc defect management method is used to manage defects on a disc in order to improve the reliability of data recorded on the disc. Examples of the disc defect management method include a slipping replacement method, wherein a defect detected during initialization of a disc is managed, and a linear replacement method, wherein an error correction code (ECC) block including a defective sector is replaced with a non-defective ECC block in a spare area to manage a defect occurring during the use of a disc.

In the slipping replacement method, a defective sector, which is detected during a verification process of checking for a defect of a disc during initialization of the disc, is not assigned a logical sector number and slipped to assign a sector next to the defective sector the logical sector number which is to be assigned to the defective sector. Thus, a reduction in a recording or reproducing velocity caused by a defect can be minimized by slipping the defective sector during recording or reproducing of data.

However, the slipping replacement method cannot be used when a defect occurs when the disc is used. This is because slipping a defective portion causes the logical sector numbers to be inconsecutive, which violates a file system data agreement. Thus, the linear replacement method is used when a defect occurs when the disc is used. In other words, an ECC block including a defective sector is replaced with an ECC block in a spare area using the linear replacement method.

Meanwhile, file system data mainly pre-determines a specific area of a user data area of a disc as an area to be used by the file system data. Thus, when a write-once information recording medium is used several times, data is sequentially recorded, without recording in an area in which the file system data is to be recorded. Thus, a drive, which supports only a general file system data that is not designed to read sequentially recorded data, cannot read the sequentially recorded data. Also, since overwriting cannot be performed on write-once information recording medium like in the case of a rewritable information recording medium, on the write-once information recording medium, the file system data cannot be assigned to a fixed position or cannot be overwritten in an identical physical position when an update of data is required. Therefore, sequential recording is performed with respect to the write-once information recording medium numerous times.

For example, data may be recorded on a conventional write-once information recording medium 100 as shown in FIG. 1. In other words, when first file system data 110 is recorded in a first position of the write-once information recording medium 100, and then first data 120 is recorded, second file system data 130, which is updated from the first file system data 110 by reflecting the first data 120, is recorded next to the first data 120. Similarly, when second data 140 is recorded next to the second file system data 130, third file system data 150, which is updated from the second file system data 130 by reflecting the second data 140, is recorded next to the second data 140. Thus, information regarding the file system data is dispersed in several positions of the conventional write-once information recording medium 100, which reduces a reproduction velocity.

Therefore, a write-once information recording medium requires a method of updating data recorded in a data area. The update of the data recorded in the data area is important because updated data is physically recorded in a different position (i.e., a different physical address) due to the characteristics of the write-once information recording medium. But, a logical address managed by a host is fixed so that the host updates only data in a fixed position so as to easily manage data.

### SUMMARY OF THE INVENTION

Aspects of the present invention provide an information recording medium that allows a logical overwriting recording method to be distinguished from other recording methods, a recording and/or reproducing method, and a recording and/or reproducing apparatus.

According to an aspect of the present invention, there is provided an information recording medium including: a lead-in area; a data area which includes a user data area in which user data is recorded and a spare area in which replacement data for updating the user data is recorded; and a lead-out area. Here, replacement enforcement flag information for indicating whether data has been recorded using logical overwriting in which the replacement data is recorded in the spare area is recorded in the lead-in area or the lead-out area.

In an aspect of the present invention, the replacement enforcement flag information is recorded in a temporary disc management area of the lead-in area or the lead-out area.

In an aspect of the present invention, the replacement data is data for updating at least one of the user data and file system data.

According to another aspect of the present invention, there is provided a recording apparatus including: a writing and/or reading unit which writes data on and/or reads data from an information recording medium including a lead-in area, a data area including a user data area in which user data is recorded and a spare area in which replacement data for updating the user data is recorded, and a lead-out area; and a controller which reads replacement enforcement flag information for indicating whether data has been recorded using logical overwriting in which the replacement data is recorded in the spare area from one of the lead-in area and the lead-out area and controls the writing and/or reading unit to update the user data with reference to the replacement enforcement flag information.

In an aspect of the present invention, the controller controls the writing and/or reading unit to record the replacement data in the spare area so as to perform the logical overwriting when the replacement enforcement flag information indicates that a replacement enforcement flag is set.

In an aspect of the present invention, the controller does not perform the logical overwriting when the replacement enforcement flag information indicates that the replacement enforcement flag is not set.

According to another aspect of the present invention, there is provided a reproducing apparatus including: a writing and/or reading unit which records data on and/or reads data from an information recording medium including a lead-in area, a data area including a user data area in which user data is recorded and a spare area in which replacement data for updating the user data is recorded, and a lead-out area; and a controller which reads replacement enforcement flag information for indicating whether data has been recorded using logical overwriting in which the replacement data is recorded in the spare area from one of the lead-in area and the lead-out area and controls the writing and/or reading unit to reproduce the user data with reference to the replacement enforcement flag information.

In an aspect of the present invention, the controller reads and reproduces the replacement data from the spare area when the replacement enforcement flag information indicates that a replacement enforcement flag is set.

According to another aspect of the present invention, there is provided a recording and/or reproducing apparatus including: a writing and/or reading unit which records data on and/or reads data from an information recording medium including a lead-in area, a data area including a user data area in which user data is recorded and a spare area in which replacement data for updating the user data is recorded, and a lead-out area; and a controller which controls the writing and/or reading unit to record replacement enforcement flag information for indicating whether data has been recorded using the logical overwriting in one of the lead-in area and the lead-out area when it is determined that the replacement data is recorded in the spare area using logical overwriting.

In an aspect of the present invention, the controller further controls the writing and/or reading unit to record the replacement enforcement flag information in a temporary disc management area of one of the lead-in area and the lead-out area.

According to another aspect of the present invention, there is provided a recording method including: reading replacement enforcement flag information for indicating whether data has been recorded using logical overwriting in which replacement data for updating user data recorded in a user data area is recorded in a spare area, from one of a lead-in area and a lead-out area of an information recording medium including the lead-in area, a data area including the user data area in which the user data is recorded and a spare area in which the replacement data is recorded, and the lead-out area; and updating the user data with reference to the read replacement enforcement flag information.

According to another aspect of the present invention, there is provided a reproducing method including: reading replacement enforcement flag information for indicating whether data has been recorded using logical overwriting in which replacement data for updating user data recorded in a user data area is recorded in a spare area, from one of a lead-in area and a lead-out area of an information recording medium including the lead-in area, a data area including the user data area in which the user data is recorded and a spare area in which the replacement data is recorded, and the lead-out area; and reproducing the user data with reference to the read replacement enforcement flag information.

According to another aspect of the present invention, there is provided a recording and/or reproducing method including: recording data on and/or reading data from an information recording medium including a lead-in area, a data area including a user data area in which user data is recorded and a spare area in which replacement data for updating the user data is recorded, and a lead-out area; and recording replacement enforcement flag information for indicating whether data has been recorded using the logical overwriting in one of the lead-in area and the lead-one area when it is determined that the replacement data is recorded in the spare area using logical overwriting.

In an aspect of the present invention, the recording of the replacement enforcement flag information include: recording the replacement enforcement flag information in a temporary disc management area of one of the lead-in area and the lead-out area.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view explaining a conventional method of recording file system data on a write-once information recording medium;

FIGS. 2A through 2C are views explaining a method of logically overwriting a file system data on a write-once information recording medium, according to an embodiment of the present invention;

FIGS. 3A and 3B are views explaining physical sector numbers recorded in the method of logically overwriting the file system data illustrated in FIGS. 2A-2C;

FIG. 4 is a schematic block diagram of a recording and/or reproducing apparatus, according to an embodiment of the present invention;

FIG. 5 is a detailed block diagram of the recording and/or reproducing apparatus of FIG. 4;

FIG. 6 is a view showing a data structure including a replacement enforcement flag, according to an embodiment of the present invention; and

FIG. 7 is a flowchart explaining a recording and/or reproducing method, according to an embodiment of the present invention.

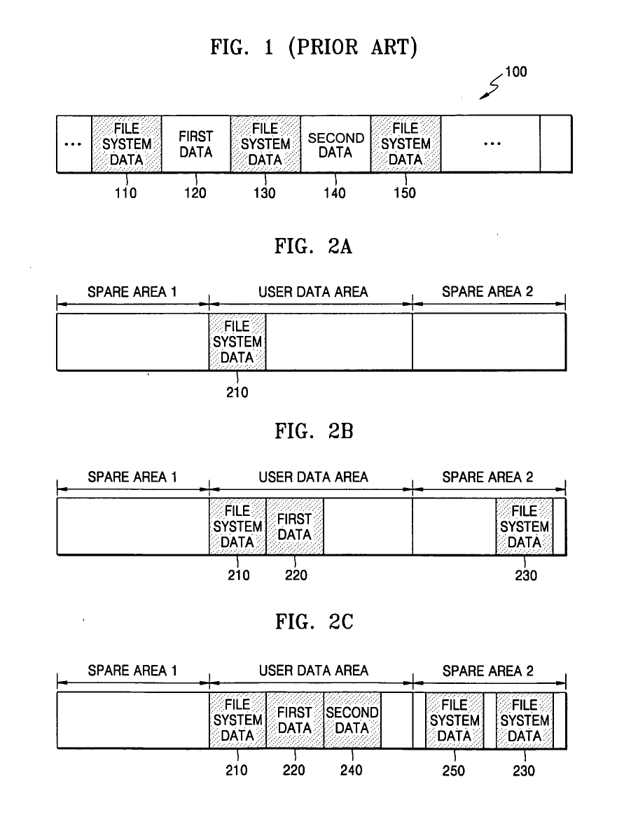

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

According to aspects of the present invention, a logical overwriting method in which data recorded in a user data area is updated according to a disc defect management method may be performed with respect to a write-once information recording medium. As a result, like in the case of a rewritable information recording medium, on the write-once information recording medium, information like the updated data may be obtained from a fixed position by fixing a logical address of the updated data.

Hereinafter, the logical overwriting method will be explained with reference to file system data. However, the logical overwriting method is not limited to the file system data and may be applied to general user data.

FIG. 2A is a view showing a case where file system data 210 to manage user data is allocated to a first fixed position of a user data area so as to be recorded as an initial file system data.

As shown in FIG. 2B, when first data 220 is recorded in the user data area, an updated file system data 230 is recorded in spare area 2 using a linear replacement method which is a kind of a disc defect management method.

As shown in FIG. 2C, when second data 240 is recorded in the user data area, another updated file system data 250 is recorded in the spare area 2 using the linear replacement method.

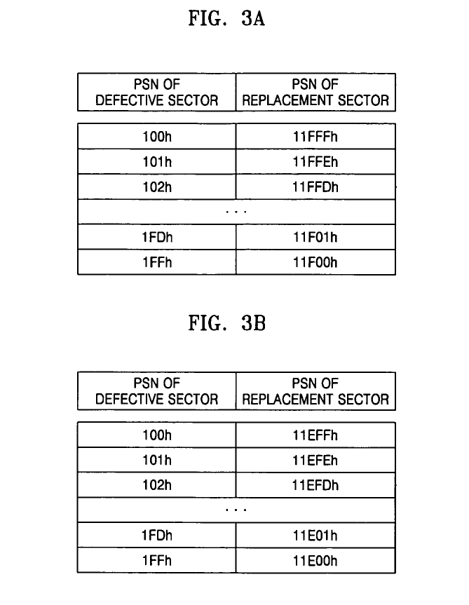

A process of fixing a logical address will be explained with reference to FIGS. 3A and 3B.

For example, when physical sector numbers of a defective section of a user data area (e.g., an area in which the file system data 210 is to be recorded) corresponding to logical sector numbers 00h through FFh are 100h through 1FFh, and data corresponding to the logical sector numbers 00h through FFh are replaced in physical sector numbers 11FFh through 11F00h of a spare area (e.g., an area in which the file system 230 is to be recorded) using first logical overwriting, defect sector information of a defect list and replacement sector information are as shown in FIG. 3A.

When the defect list is made using the first logical overwriting, and then the logical sector numbers 00h through FFh are replaced with physical sector numbers 11EFFh through 11E00h using second logical overwriting, then defect sector information and replacement sector information of the defect list are as shown in FIG. 3B. Thus, file system data can be detected from a fixed logical sector number by searching a final defect list including a logical sector number and a physical sector number corresponding to the logical sector number.

Accordingly, in aspects of the present invention, file system data can be updated using a conventional disc defect management method so as to fix a physical sector number of the file system data. Thus, an address of the file system data can be obtained from a fixed position. Although the process of fixing a logical address has been described with reference to file system data, it may be also applied to user data.

As described above, in the case of DVD-R/DVD+R and write-once information recording media, information such as file system data need not be searched for throughout the information storage medium due to updating of the file system data, i.e., logical overwriting. Thus, the file system data can easily be updated and accessed.

Accordingly, both of a logical overwriting method and an existing recording method can be applied to a write-once information recording medium.

Therefore, when a write-once information recording medium is loaded into a drive, a recording and/or reproducing apparatus is required to recognize which data recording method has been performed with respect to the write-once information recording medium (i.e., whether logical overwriting has been performed with respect to the write-once information recording medium). Also, when recording is performed with respect to a bare information recording medium, the recording and/or reproducing apparatus is required to show which recording method is to be performed with respect to the bare information recording medium (i.e., whether logical overwriting is to be performed with respect to the bare information recording medium).

Accordingly, a process of distinguishing the logical overwriting method from other existing recording methods is needed.

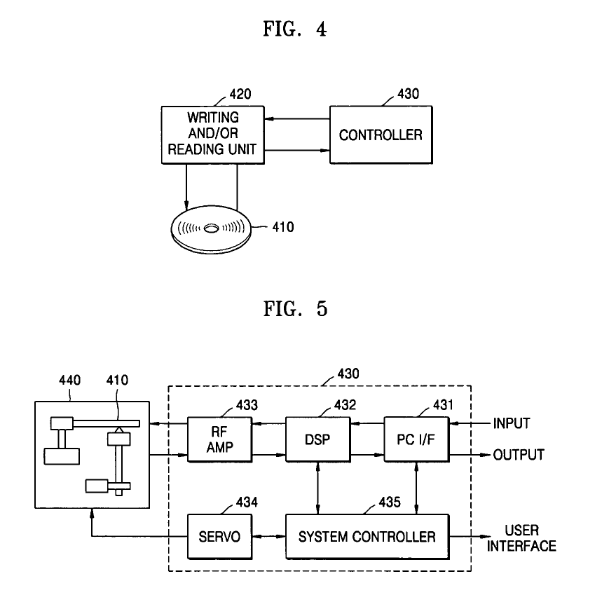

FIG. 4 is a schematic block diagram of a recording and/or reproducing apparatus, according to an embodiment of the present invention. Referring to FIG. 4, the recording and/or reproducing apparatus performs recording and reproduction and includes a writing and/or reading unit 420 and a controller 430.

The writing and/or reading unit 420 records data on and/or reads data from a disc 410, which is an information recording medium, under control of the controller 430.

The controller 430 controls the writing and/or reading unit 420 to record data in blocks, which are predetermined recording units, or processes data read by the writing and/or reading unit 420 to obtain effective data. It will be fully understood by those of ordinary skill in the art that although aspects of the present embodiment have been described with respect to file system data, it may be also applied to user data.

During recording, the controller 430 controls the writing and/or reading unit 420 to record file system data according to a file system recording method which is to be used for the disc 410. In other words, when recording is first performed with respect to a bare information recording medium, the controller 430 determines which type of recording method is used to record file system data and controls the writing and/or reading unit 410 to record information in accordance with the determined recording method in a predetermined portion of the bare information recording medium. When recording is performed with respect to a write-once information recording medium including a portion in which recording has already been performed, the controller 430 controls the writing and/or reading unit 420 to read information regarding a file system data recording method stored in a predetermined portion of the write-once information recording medium to determine which type of file system data recording method has been performed with respect to the write-once information recording medium and to record file system data according to the determined file system data recording method. This will be explained in more detail later.

During reproduction, the controller 430 controls the writing and/or reading unit 420 to read data according to the file system data recording method which has been used for the disc 410. In other words, the controller 430 controls the writing and/or reading unit 420 to read information regarding the file system data recording method stored in a predetermined portion of the disc 410 to determine which type of file system data recording method has been adopted for the disc 410 and to read the file system data according to the adopted file system data recording method.

FIG. 5 is a more detailed block diagram of the recording and/or reproducing apparatus of FIG. 4. Referring to FIG. 5, the recording and/or reproducing apparatus (hereinafter referred to alternately as a disc drive) includes a pickup 440 which serves as the writing and/or reading unit 420 of FIG. 4. The disc 410 is mounted in the pickup 440. The disc drive also includes the controller 430 including a personal computer interface (PC I/F) 431, a digital signal processor (DSP) 432, a radio frequency amplifier (RF AMP) 433, a servo 434, and a system controller 435.

During recording, the PC I/F 432 receives data to be recorded and a write command from a host (not shown).

The system controller 435 performs initialization processes for recording. In particular, according to aspects of the present invention, the system controller 435 determines whether the disc 410 is a bare information recording medium. When the system controller 435 determines that the disc 410 is a bare information recording medium, the system controller 435 determines whether file system data will be recorded according to a logical overwriting method (i.e., whether the file system data will be updated according to a disc defect management method). Thereafter, the system controller 435 sets a value of a replacement enforcement flag according to the determination result. When the system controller 435 determines that the disc 410 is not a bare information recording medium, the system controller 435 reads and recognizes the value of the replacement enforcement flag recorded in a predetermined portion of the disc 410. Also, the system controller 435 controls the performance of recording with respect to a write-once information recording medium using a logical overwriting method or an existing recording method according to the set value of the replacement enforcement flag or the recognition value of the replacement enforcement flag. The replacement enforcement flag will be explained later.

It has been described that the system controller 435 performs the above-described functions. However, the system controller 435 may share the above-described functions with a controller of the host. Alternatively, the controller of the host may serve as a main device to perform the above-described functions, and the system controller 435 may serve as an auxiliary device of the controller of the host.

The DSP 432 receives data to be recorded from the PC I/F 431, adds additional data such as parity bits or the like to the data for error correction, performs ECC coding with respect to the data to which the additional data has been added, generates ECC blocks, and modulates the ECC blocks using a predetermined method. The RF AMP 433 converts the data output from the DSP 432 into an RF signal. The pickup 440 records the RF signal output from the RF AMP 433 on the disc 410. The servo 434 receives a servo control command from the system controller 435 to servo-control the pickup 440 according to the servo control command.

During reproduction, the PC I/F 431 receives a reproduction command from the host. The system controller 435 performs an initialization process for reproduction. In particular, according to aspects of the present invention, the system controller 435 reads the value of the replacement enforcement flag recorded in the predetermined portion of the disc 410 to read data from the disc 410 according to the set flag value.

The pickup 440 irradiates a laser beam onto the disc 410 and receives the laser beam reflected from the disc 410 to output a light signal. The RF AMP 433 converts the light signal output from the pickup 440 into an RF signal, provides modulated data obtained from the RF signal to the DSP 432, and provides a servo control signal obtained from the RF signal to the servo 434. The DSP 432 demodulates the modulated data, performs ECC coding with respect to the demodulated data, and outputs the data which has undergone ECC coding.

The servo 434 receives a servo signal from the RF AMP 433 and the servo control command from the system controller 435 to servo-control the pickup 440. The PC I/F 431 receives data from the DSP 432 and transmits the data to the host.

The above-mentioned replacement enforcement flag and a data structure of aspects of the present invention will now be described in detail.

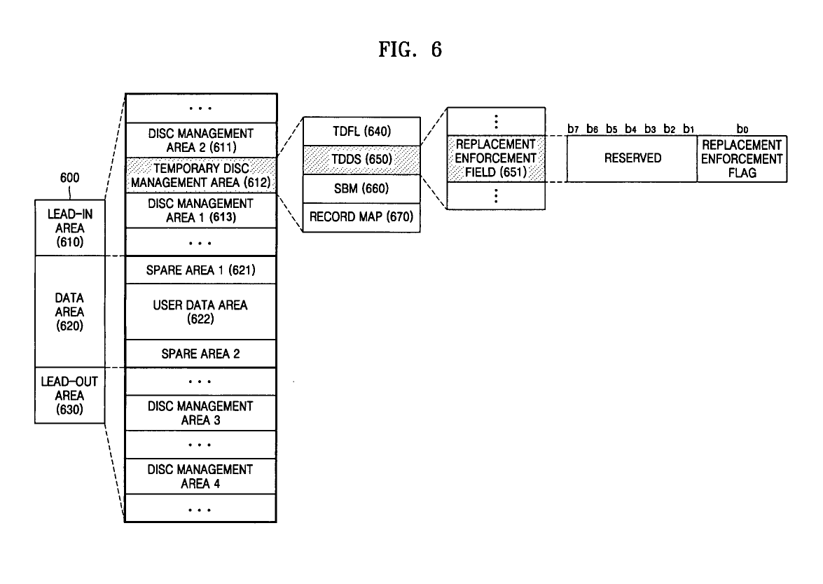

FIG. 6 is a view showing the structure of data recorded on a write-once information recording medium, according to an embodiment of the present invention. The write-once information recording medium having a structure 600 includes a lead-in area 610, a data area 620, and a lead-out area 630.

The lead-in area 610 includes disc management areas 611 and 613, a temporary disc management area (TDMA) 612, and so on.

The TDMA 612 refers to an area in which information for temporary defect management and temporary disc management information to manage the write-once information recording medium is to be recorded.

The TDMA 612 includes a temporary defect list (TDFL) 640, a temporary disc definition structure (TDDS) 650, a space bit map (SBM) 660, and a record map 670.

The TDFL 640 includes a defect list including information on the status, position of defect and replacement.

The TDDS 650 includes position pointers of the TDFL 640, the SBM 660, the record map 670, and a drive area. Also, the TDDS 650 includes information on a position and size of a spare area 621 allocated during initialization, write protection information, information on a position and size of a TDMA allocated to the data area 620, information on a user data area 622, information on positions of the spare area to be replaced, a last recorded address of the user data area, and the like. In particular, according to aspects of the present invention, the TDDS 650 includes a replacement enforcement field 651 in which information indicating whether data has been recorded using a logical overwriting method is recorded.

The replacement enforcement field 651 contains 8 bits, 7 significant bits which are reserved and one least significant bit which is used as a replacement enforcement flag. In other words, “1” may be recorded in the replacement enforcement flag to indicate that recording has been performed with respect to the write-once information recording medium using a logical overwriting method. “0” may be recorded in the replacement enforcement flag to indicate that recording has been performed with respect to the write-once information recording medium using an existing recording method.

It is preferable, but not necessarily required, that such bit values are set and then fixed during initialization. This is because the use of two recording methods with respect to one information recording medium causes a system to be too complicated and confuses a user.

Therefore, when the logical overwriting method is used with respect to the write-once information recording medium during initialization, a bit value of “1” is allocated to the replacement enforcement flag. Thus, when a write command is transmitted to an area in which data has been previously recorded, the area is not determined as a defective area. As a result, the disc drive updates data as if managing a defect. When the logical overwriting method is not used with respect to the write-once information recording medium, a bit value of “0” is allocated to the replacement enforcement flag. Thus, when the write command is transmitted to the area in which the data has been previously recorded, the host is informed that data has been recorded and the disc drive waits for a next command of the host.

The SBM 660 refers to a map which indicates whether recording has been performed in the user data area in which bit values indicate whether recording has been performed with respect to each cluster of the user data area.

Similar to the SBM 660, the record map 670 divides the user data area into several areas to indicate whether data has been recorded in the several areas of the user data area using entry information. The entry information includes state information, start address information, and end address information. Thus, information on an area designated by an entry in the entry information refers to a recording state map of a user data area represented with information on the status of the designated area. The state information includes information indicating whether data has been recorded in the designated area and information indicating whether the designated area is usable.

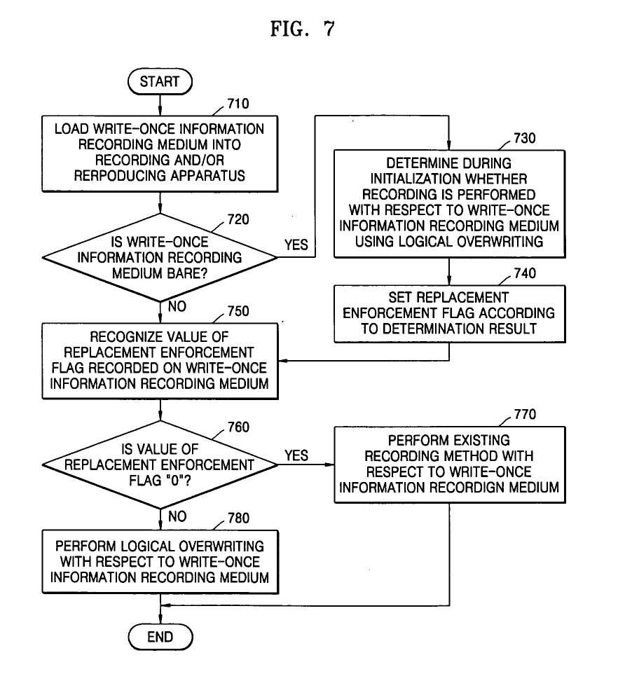

FIG. 7 is a flowchart explaining a method of using a write-once information recording medium, according to an embodiment of the present invention. Referring to FIG. 7, in operation 710, a write-once information recording medium 410 is loaded into the recording and/or reproducing apparatus shown in FIGS. 4 and 5.

In operation 720, a system controller 435 reads predetermined information recorded on the write-once information recording medium 410 to determine whether the write-once information recording medium 410 is bare.

If in operation 720, the system controller 435 determines that the write-once information recording medium 410 is not bare, the process moves on to operation 750.

If in operation 720, the system controller 435 determines that the write-once information recording medium 410 is bare, then in operation 730, a determination is made during initialization of the write-once information recording medium 410 whether recording is performed with respect to the write-once information recording medium 410 using logical overwriting. Here, whether recording is performed with respect to the write-once information recording medium 410 using the logical overwriting may be determined by a selection of a user, a determination of the system controller 435 of the disc drive according to the environment of the disc drive, or a determination of a controller of a host (not shown).

In operation 740, as temporary defect management information of a TDMA, a least significant bit value of a replacement enforcement flag of a replacement enforcement field is set to “1” or “0” according to the determination result in a TDMA of the write-once information recording medium 410. After the replacement enforcement flag is set the method proceeds to operation 750.

In operation 750, the bit value of the replacement enforcement flag recorded on the write-once information recording medium 410 is read and recognized. If in operation 720, the system controller 435 determines that the write-once information recording medium 410 is not bare, the value of the replacement enforcement flag recorded on the write-once information recording medium 410 is read. However, when a recording method is determined during the initialization of the write-once information recording medium 410, the value of the replacement enforcement flag may be recognized according to the determined recording method.

In operation 760, a determination is made whether the value of the replacement enforcement flag is “0.”

If in operation 760, it is determined that the value of the replacement enforcement flag is not “0”, then in operation 780, a logical overwriting method is used with respect to the write-once information recording medium 410. As previously described, in the logical overwriting method, when a data write command is transmitted to an area in which data has been previously recorded, the area is treated as a defect area. Thus, data recorded in the defect area is updated using a disk defect management method.

If in operation 760, it is determined that the value of the replacement enforcement flag is “0”, then in operation 770, an existing recording method is performed with respect to the write-once information recording medium 410. Here, in the existing recording method, when a data write command is transmitted to an area in which data has been previously recorded, the command is regarded as an error.

As described above, in an information recording medium, a recording and/or reproducing method, and a recording and/or reproducing apparatus, according to aspects of the present invention, for a method of distinguishing a logical overwriting method from other existing recording methods can be adopted with respect to a write-once information recording medium. As a result, a user can use the logical overwriting method and the other existing recording methods with respect to the write-once information recording medium.

Although a few embodiments of the present invention have been shown and described, it would be appreciated by those skilled in the art that changes may be made in these embodiments without departing from the principles and spirit of the invention, the scope of which is defined in the claims and their equivalents.

1. An information recording medium for use in a recording and/or reproducing apparatus, comprising:
a lead-in area;
a data area which comprises a user data area in which user data is recorded and a spare area in which replacement data used to update the user data is recorded; and
a lead-out area,
wherein replacement enforcement flag information indicating whether the replacement data is recorded by the recording and/or reproducing apparatus using logical overwriting in the spare area is recorded in one of the lead-in area or the lead-out area.

2. The information recording medium of claim 1, wherein the replacement enforcement flag information is recorded in a temporary disc management area of one of the lead-in area or the lead-out area.

3. The information recording medium of claim 1, wherein the replacement data is data updating at least one of the user data or file system data.

4. A recording apparatus, comprising:
a writing and/or reading unit which writes data on and/or reads data from an information recording medium comprising a lead-in area, a data area comprising a user data area in which user data is recorded and a spare area in which replacement data used to update the user data is recorded, and a lead-out area; and
a controller which reads replacement enforcement flag information indicating whether data has been recorded using logical overwriting in which the replacement data is recorded in the spare area from one of the lead-in area or the lead-out area and controls the writing and/or reading unit to update the user data with reference to the replacement enforcement flag information.

5. The recording apparatus of claim 4, wherein the controller controls the writing and/or reading unit to record the replacement data in the spare area so as to perform the logical overwriting when the replacement enforcement flag information indicates that a replacement enforcement flag is set.

6. The recording apparatus of claim 4, wherein the controller does not perform the logical overwriting when the replacement enforcement flag information indicates that a replacement enforcement flag is not set.

7. A reproducing apparatus, comprising:
a writing and/or reading unit which records data on and/or reads data from an information recording medium comprising a lead-in area, a data area comprising a user data area in which user data is recorded and a spare area in which replacement data used to update the user data is recorded, and a lead-out area; and
a controller which reads replacement enforcement flag information indicating whether the replacement data is recorded in the spare area using logical overwriting from one of the lead-in area or the lead-out area and controls the writing and/or reading unit to reproduce the user data with reference to the replacement enforcement flag information.

8. The reproducing apparatus of claim 7, wherein the controller reads and reproduces the replacement data from the spare area when the replacement enforcement flag information indicates that a replacement enforcement flag is set.

9. A recording and/or reproducing apparatus, comprising:
a writing and/or reading unit which records data on and/or reads data from an information recording medium comprising a lead-in area, a data area comprising a user data area in which user data is recorded and a spare area in which replacement data used to update the user data is recorded, and a lead-out area; and
a controller which controls the writing and/or reading unit to record replacement enforcement flag information indicating whether the replacement data has been recorded using logical overwriting in one of the lead-in area or the lead-out area when is the controller determines that the replacement data is recorded in the spare area using logical overwriting.

10. The recording and/or reproducing apparatus of claim 9, wherein the controller further controls the writing and/or reading unit to record the replacement enforcement flag information in a temporary disc management area of one of the lead-in area or the lead-out area.

11. A recording method, comprising:
reading replacement enforcement flag information indicating whether replacement data updating user data recorded in a user data area is recorded in a spare area using logical overwriting, from one of a lead-in area or a lead-out area of an information recording medium comprising the lead-in area, a data area comprising the user data area in which the user data is recorded and the spare area in which the replacement data is recorded, and the lead-out area; and
updating the user data with reference to the read replacement enforcement flag information.

12. The recording method of claim 11, wherein the update of the user data comprises recording the replacement data in the spare area when the replacement enforcement flag information indicates that a replacement enforcement flag is set.

13. The recording method of claim 11, wherein the logical overwriting is not performed when the replacement enforcement flag information indicates that the replacement enforcement flag is not set.

14. A reproducing method, comprising:
reading replacement enforcement flag information indicating whether replacement data updating user data recorded in a user data area is recorded in a spare area, from one of a lead-in area or a lead-out area of an information recording medium comprising the lead-in area, a data area comprising the user data area in which the user data is recorded and the spare area in which the replacement data is recorded, and the lead-out area; and
reproducing the user data with reference to the read replacement enforcement flag information.

15. The reproducing method of claim 14, wherein the reproduction of the user data comprises reading and reproducing the replacement data from the spare area when the replacement enforcement flag information indicates that a replacement enforcement flag is set.

16. A recording and/or reproducing method, comprising:
recording data on and/or reading data from an information recording medium comprising a lead-in area, a data area comprising a user data area in which user data is recorded and a spare area in which replacement data updating the user data is recorded, and a lead-out area; and
recording replacement enforcement flag information indicating whether data has been recorded using the logical overwriting in one of the lead-in area or the lead-out area when the replacement data is recorded in the spare area using logical overwriting.

17. The recording and/or reproducing method of claim 16, wherein the recording of the replacement enforcement flag information comprises:
recording the replacement enforcement flag information in a temporary disc management area of one of the lead-in area or the lead-out area.

18. A write-once information storage medium for use with a recording and/or reproducing apparatus, comprising:
a first recording area which stores data recorded by the apparatus; and
a second recording area which stores file system data recorded by the apparatus, wherein the file system data is updated each time the apparatus records data in the first recording area according to a disc defect management method.

19. A method of managing data in a write-once storage medium, comprising:
updating file system data according to a disc defect management method in a spare area of the storage medium.

20. A recording and/or reproducing apparatus, comprising:
an optical pickup which records data on and/or reads the data from a surface of a write-once information storage medium; and
a controller which controls the optical pickup to record and/or reproduce the data on the surface of the information storage medium and stores an initial file system data on the surface of the information storage medium,
wherein the information storage medium comprises a first recording area which stores the data and the initial file system data recorded by the controller, and
a second recording area which stores update file system data recorded by the apparatus, wherein the update file system data is updated each time the apparatus records data in the first recording area according to a disc defect management method.
